(19) United States
(12) Patent Application Publication
(10) Pub. No.: US 2003/0189486 A1
(43) Pub. Date: Oct. 9, 2003

(54) Intruder monitor system

(76) Inventor: Johnny Hilton-Bey, Baltimore, MD (US)

Correspondence Address: Johnny Hilton-Bey, 5628-D Loch Raven Blvd., Baltimore, MD, 21239, US

(21) Appl. No.: 10/078,333

(22) Filed: Apr. 3, 2002

(51) Int. Cl. G08B 13/00

(52) U.S. Cl. 340/541; 348/152

(57) ABSTRACT

This device, Intruder Monitor System, is the first “I System that a person can buy to hook up to a Television and VCR. This is the first Security System to monitor and record activity in and outside of a home or building by itself. The Motion Detectors controls the cameras, TV. and VCR.

### CROSS-REFERENCE TO RELATED APPLICATION

I entered the Intruder Monitor System into the Disclosure Document Program. I mailed it out on Jan. 17, 2002. I have not received a Disclosure Document Number yet.

### STATEMENT REGARDING FEDERALLY SPONSORED RESEARCH OR DEVELOPMENT:

I use to be a Passenger Assistance Link Operator for the railroad. I use to monitor the railroad stops with a camera mounted in the stations from a office building. I also went around to several stores that sell Security Systems and there is no such system. I also went to the University Of Maryland at College Park, they have a Reference Collection Of United State Patent Library where research is done.

### REFERENCE TO A MICROFICHE APPENDIX

Not Applicable.

### BACKGROUND OF THE INVENTION

The Intruder Monitor System is design for the Security Field. At this point and time you need a person to monitor a place inside and outside with cameras and a Monitor System.

### BRIEF SUMMARY OF THE INVENTION

The Intruder Monitor System is design to monitor a place without a person at the controls pushing buttons or turning knobs. This Security System monitor and records and sound off alarms when a person is out of his or her place without them being there. The Intruder Monitor System also let a person watch TV. monitoring a place without setting off the alarm when they are at the monitor and controls or not at the controls. The Universal Device that hooks up to the TV. and VCR. has a light that flashes on and off when the Motion Detector is set off to let them know there is a intruder. The person that is watching the TV., can turn the TV. to the Monitor Channel. They then can see what is happening inside or outside of a place.

### BRIEF DESCRIPTION OF THE SEVERAL VIEWS OF DRAWING

Not Applicable.

### DETAILED DESCRIPTION OF THE INVENTION

The Intruder Monitor System comes with a Universal Monitor Device that can be hooked up to any Television that works with a Remote Control and Video Cassette Recorder. The Universal Monitor Device is the device that receives the transmitted images sent from the cameras. It also come with a camera or several cameras with a built in Motion Detector. It comes with a Motion Detector with a Key Pad on it. The Key Pad also operates like a Universal Remote Control by entering codes in it to turn the TV. and VCR. on and off when activated. This Key Pad lets a person put its own code in the Security System to turn the system off and on. This is how the Security System works, when a person have the system hooked up. Before a person leaves out of a place, by pushing a button, the person can set the Security System. The Security System allows the person several seconds or minutes to leave out of a place before arming itself.

When a intruder enters or break in a place. The Motion Detector picks up the intruders movement and sound. The alarm goes off, the Motion Detector turns on the TV. and VCR. like a Universal Remote Control does to record. When a person have several cameras with this system. The first camera with the Motion Detector that picks up movement. That is the camera that the recorder will pick up. That camera image will be recorded for a length of time. The camera does a rotation cycle when recording camera to camera. When the TV. and VCR. is turned on by the Motion Detectors. The VCR. must be on the Monitor Channel to video the intruders, Example: channel 3 or 4. When the TV. comes on it can be on any channel except the Monitoring Channel. The intruders would see that program and may not know they are being taped. The recording will go on as long as the alarm stays on. Once the alarm goes off the TV. and VCR. turns off as well. Once the intruder here the alarm they usually leave. If they do not leave the Motion Detector will pick up their movement in several minutes and the alarm will sound again and the recording will continue. When monitoring a place without, the Key Pad Motion Detector turned on for the alarm to sound. A person must use the button on the VCR. or the remote to record.

1. What I claim as my invention is, the Intruder Monitor System.” “I Johnny Hilton-Bey, claim the Security System will monitor a place without a person at the control and record and sound the alarms.” If a person have a small TV that can be hooked up to the Intruder Monitor System they can monitor their place when they are out walking to the store or out driving around. If a person have two or more of these Intruder Monitor System. A person can have the camera hooked up to his or her place. Give one of the Universal Monitor Device to another person to hook up to another TV. and VCR. that they can trust to help secure the recording tape. This Security System also can be used to check on family or friends with their written concent and they knowing of it. The Motion Detectors light stays on in a place with this system to let someone know somebody has been in their place. The Motion Detector turns on and off the Television. The Motion Detector also turns the recorder on and off. The other Motion Detector Lights goes out when the alarm stop sounding. This Security System, if hooked up to a TV. or VCR. with Cable or a Game System. The Game and Cable System will not interfere with the Security System.
